(19) United States
(12) Patent Application Publication
(10) Pub. No.: US 2002/0194827 A1
(43) Pub. Date: Dec. 26, 2002

(54) Modular power head for walk-behind mower

(76) Inventors: Jimmy N. Eavenson SR., Aurora, OH (US); James Cykon, Warren, OH (US)

Correspondence Address: Roger D. Emerson, 4421 Ranchwood Spur, Akron, OH, 44333-1343, US

(21) Appl. No.: 09/887,596

(22) Filed: Jun. 22, 2001

(51) Int. Cl. A01D 34/43

(52) U.S. Cl. 56/17.2

(57) ABSTRACT

A vegetation mower power head frame having a fixedly attached axle receiving member and a selectively removable axle member received by the axle receiving member for providing modularity with respect to changing the wheel base of the mower and for facilitating easy replacement of the axle during repair. The axle member is secured to the axle receiving member by a retainer pin preventing lateral movement relative thereto. The power head frame is also fashioned with multiple sets of holes for securing one of a plurality of engines having a different configuration or size.

### I. BACKGROUND OF THE INVENTION

A. Field of the Invention

This invention relates to the art of walk-behind mowers and, more specifically, to the powerhead frames, especially as related to a modular powerhead frame.

B. Description of the Related Art

Generally, walk-behind mowers, and especially wide area mowers, have a powerhead frame onto which various components of the mower are mounted, which include: drive wheels, an engine, steering means and an implement, such as a mower deck. The powerhead frame is assembled with specific components adapted for use on a particular powerhead frame. For example, an axle assembly having a specific wheel base is matched and assembled onto a certain configuration or size powerhead frame.

U.S. Pat. No. 4,248,034 to Jackson et al. discloses an adjustable axle support system for a lawn mower for supporting the wheels and blade housing at a pre-selectable elevation. The patent further discloses that the system includes brackets having slots formed therein for receiving axle bearings, which are slidable on the axles and are received within the bracket slots. The object of the patent is adjustment of the height of the blade housing and, in turn, the cutting blade, which is achieved by moving the axles along the bracket slots. This patent does not disclose incorporating different size axles, but, rather, is intended for the adjustment of the cutting height of the mower.

U.S. Pat. No. 4,212,364 to Dobberpuhl discloses an axle support frame that is vertically pivotally mounted at the rear of the mower. The patent further discloses an adjustment mechanism that is provided for holding the support frame in selected positions according to the desired cutting height. The object of the invention of this patent is to provide a drive wheel mounting structure by which both wheels can be simultaneously vertically adjusted by manipulating a single adjustment lever. This patent does not disclose that the frame allows for different length axles to be attached providing powerhead frame modularity.

One aspect of mower powerhead frames is that an axle cannot easily be replaced. Typically, in replacement thereof, the mower requires considerable disassembly, resulting in substantial repair time and the associated costs of labor and materials to affect the repairs. As wear of the axle components and the surrounding support structure is common, it would therefore be advantageous to provide a way for reducing the time and cost associated with repair of the axle components as related to a powerhead frame.

It would also be advantageous to adapt a mower to accommodate different sizes and types of implements. However different sized implements require alterations to the mower such as increased engine power capacity or a different length wheelbase and wheels. Therefore, it would be advantageous to provide a powerhead frame that could receive various sizes and configurations of engines and axles to accommodate different mower implements.

The following invention discloses an apparatus and method for solving the aforementioned problems.

Thus, the difficulties inherent in the art are overcome in a way that is simple, inexpensive and efficient, while providing better and more advantageous results.

### II. SUMMARY OF THE INVENTION

It is the object of the present invention to provide a powerhead frame for use on vegetation mowers that can be manufactured to easily accommodate a plurality of different length axles.

It is another object of the invention to provide a powerhead frame for use on vegetation mowers that can be manufactured to accommodate a plurality of different mower engines.

It is still another object of the present invention to provide a powerhead frame, wherein the axle can be easily and quickly installed or repaired.

It is further still another object of the present invention to provide a method for quickly replacing the axle of a powerhead frame for use on a vegetation mower.

It is yet another object of the present invention to provide a method for assembling a vegetation mower.

In accordance with the present invention, there is provided a frame having a top mounting plate, also called a first frame member, and side plates extending downwardly therefrom at substantially right angles at opposite ends of the first frame member, and in which the side plates fixedly receive an axle-receiving member. Reinforcement plates are attached to the outer surface of the side plates at the position where the axle receiving member is attached to the side plates for use in strengthening the side plates against wear or deterioration, and wherein is provided an aperture through which an axle extends. The axle is selectively removable within the axle-receiving member and secured thereto by a fastening means.

In accordance with another aspect of the present invention the frame has fashioned therein a series of holes threaded for use in receiving bolts, which secure the engine to the frame. Pluralities of threaded holes patterns are provided to accommodate the different mounting patterns of various engine configurations. In this way, the frame may fixedly receive one of a plurality of different engines.

Other objects and advantages of the invention will appear from the following detailed description of the preferred embodiment of the invention, with reference being made to the accompanying drawings.

### III. BRIEF DESCRIPTION OF DRAWINGS

The invention may take physical form in certain parts and arrangement of parts, a preferred embodiment of which will be described in detail in this specification and illustrated in the accompanying drawings, which form a part hereof and wherein:

FIG. 1 is a perspective view of a walk-behind wide-area mower.

FIG. 2 is a cut-away perspective view of a modular powerhead frame.

FIG. 3 is a perspective, close-up view of a side plate of a modular powerhead frame with the reinforcement plate fashioned thereon.

FIG. 4 is a cut-away partial perspective view of the side plate of a modular powerhead frame showing the axle received within the axle-receiving member and fastening means.

FIG. 5 is a perspective view of a modular powerhead frame, axle-receiving member and axle, showing a plurality of mounting holes patterns.

### IV. DETAILED DESCRIPTION OF THE INVENTION

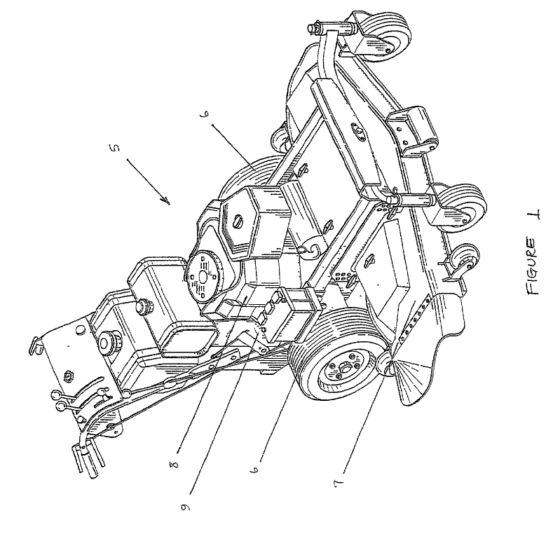

Referring now to the drawings wherein the showings are for purposes of illustrating a preferred embodiment of the invention and not for purposes of limiting the same, FIG. 1 shows a walk-behind mower 5 for use in cutting associated vegetation. The mower 5 is comprised of a powerhead frame 9, at least two ground-engaging wheels 6 operatively connected to the frame, an engine 8 for providing power to the ground-engaging wheels 6 and an implement, which in the preferred embodiment is a mower deck 7.

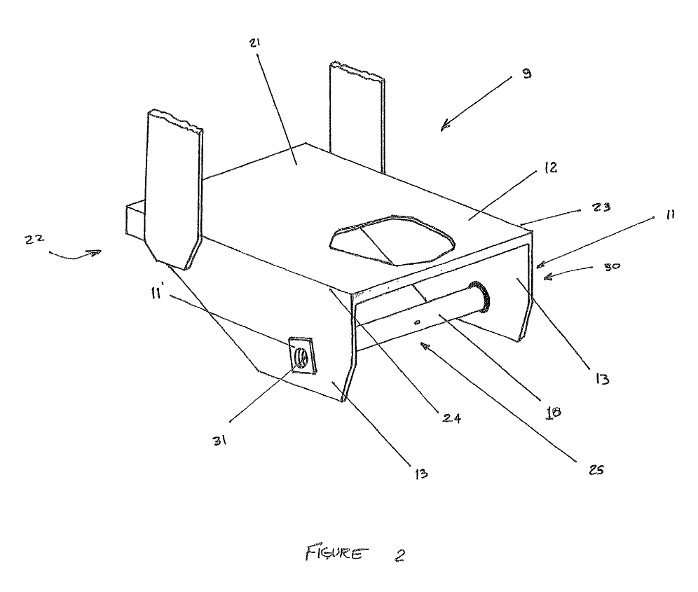

Referring now to FIG. 2, a modular powerhead frame is depicted, as shown generally at 9. The powerhead frame is comprised of a top mounting plate 12 upon which is affixed an engine 8 for use in providing power to drive the implement 7. In the preferred embodiment, and as shown in FIG. 1, the implement is a mower deck 7. However, in an alternate embodiment, any implement can be chosen with sound engineering judgment as is appropriate for a walk-behind mower. The top mounting plate 12, generally planar in shape, has top and bottom surfaces 21, 22 and first and second ends 23, 24. Extending from the bottom surface 22 at each of said first and second ends 23, 24 are generally planar side plates 13, 13′. Each of the generally planar side plates 13, 13′ extend downwardly substantially perpendicular to the top mounting plate 12, forming a first concave region 25. A first axle receiving member 10 is disposed within the first concave region 25 and fixedly mounted to the side mounting plates 13, 13′. In the preferred embodiment the axle receiving member 10 is welded to the side plates 13, 13′ although any means of fixedly attaching the axle receiving member 10 may be chosen with sound engineering judgment as is appropriate for power head frames. The axle receiving member 10 has a longitudinal axis that is substantially perpendicular to each of the side mounting plates 13, 13′ and substantially parallel to the top mounting plate 12. The axle receiving member 10 is also generally tubular in shape, having first and second ends and first and second openings 30, 31, wherein a passageway communicates said first and second openings 30, 31.

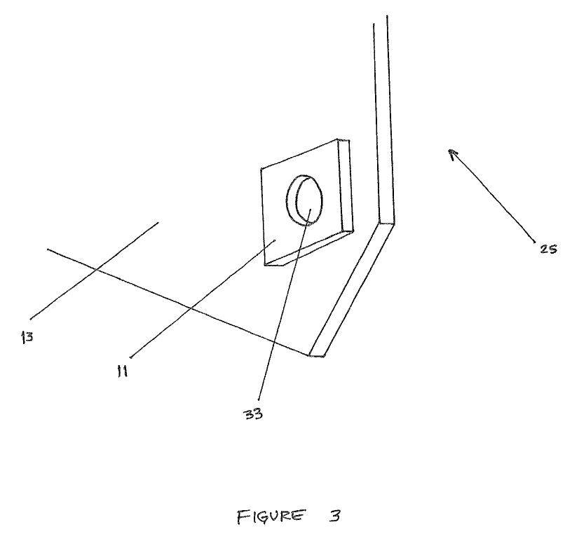

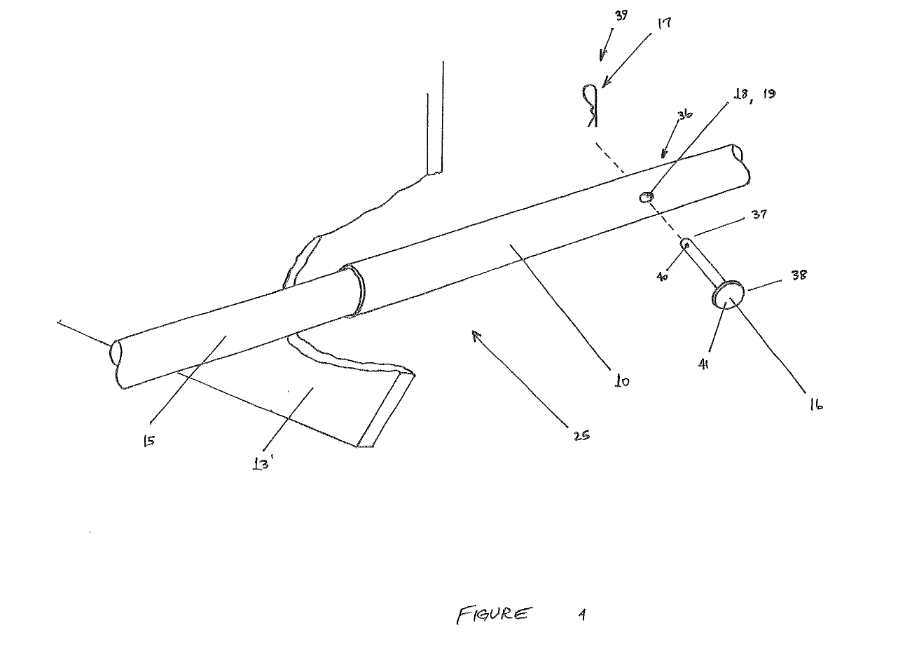

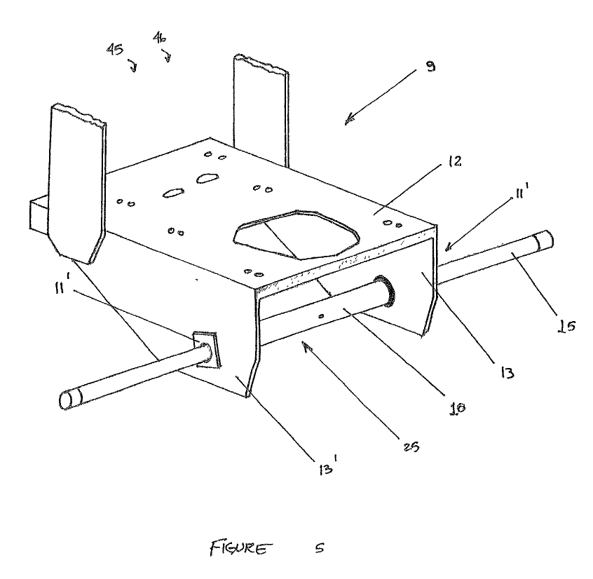

Referring now to FIG. 3, a cutaway perspective view of side plate 13′ and reinforcement plate 11′ is shown. In the preferred embodiment, the reinforcement plates 11, 11′, 11 not shown in FIG. 3, are separate components that are fixedly attached to the outer surface of each of the side plates 13, 13′ by way of welding or other fastening means such as is appropriate for power head frames. However, in an alternate embodiment, the reinforcement plates 11, 11′ can be fashioned as an integral part of the side plate 13, 13′. The reinforcement plates can be of any thickness and configuration as chosen with sound engineering judgment as is appropriate for a modular powerhead frame. Openings 33, 34, 34 not shown in FIG. 3, are formed within each of the side plates 13, 13′ and reinforcement plates 11, 11′, communicating the first concave region 25 to the exterior of the modular powerhead frame 9. When the axle receiving member 10, shown in FIG. 2, is fixedly attached to the frame 9, the openings 33, 34 communicate the exterior of the frame 9 to the inner region of the generally tubular axle receiving member 10. In this way, an axle member 15, shown in FIG. 4 and 5, may be received within the openings 33, 34 of the reinforcement plates 11, 11′, the side plates 13, 13′ and by the axle receiving member 10, which will be discussed in a subsequent paragraph.

With reference now to FIG. 4, FIG. 4 shows a cutaway perspective view of the side plate 13′, depicting a axle receiving member 10 and a selectively removable axle member 15 received therein. The axle receiving member 10 has third and fourth openings 18, 19 fashioned between each of the first and second ends, concentrically about an axis perpendicular to the longitudinal axis of the axle receiving member 10. The axle member 15 has a corresponding hole 36 fashioned therein perpendicular to the longitudinal axis thereof. Upon laterally positioning the axle member 15 within the axle receiving member 10 and concentrically aligning the first hole 36 of the removable axle member 15 with the third and fourth openings 18, 19 of the axle receiving member 10, an insertion pin 16 may be received within each of the aforestated openings and holes respectively. The pin 16 is dimensioned such that it has a slip fit with respect to the hole 36 and openings 18, 19. In the preferred embodiment, the aforestated holes and openings are circular in shape and correspond to a cylindrical contour of the insertion pin 16. The insertion pin 16 has first and second ends 37, 38. A hole 40 is fashioned at the first end 37 of the insertion pin 16 for use in receiving a retainer 17, such as a cotter pin 39. A head 41 is fashioned at the second end of the insertion pin 16 for use in limiting the insertion distance of the pin 16 within the openings 18, 19 and hole 36. In this way the pin 16, when secured in place by the retainer 17, is prevented from disengaging the axle member 15 and axle receiving member 10. In an alternate embodiment, any such fastening means for securing the removable axle member 15 to the fixed axle assembly 10 can be chosen with sound engineering judgment. In that fastening means are well known in the art no further explanation will be given.

With reference now to FIG. 5, in this way, by the aforestated description, a powerhead frame 9 is assembled having a fixedly mounted axle receiving member 10, in which a removable axle member 15 is selectively received and wherein the removable axle member 15 is secured to the axle receiving member 10 from lateral movement relative thereto by a pin 16. Inasmuch, in the preferred embodiment, as the powerhead frame 9 and attached assemblies 10, 15 are for use on a walk-behind mower 5, ground engaging wheels 6 are operatively connected to the removable axle member 15 for use in providing mobility to the mower 5. In that wheels, operatively connected to axles, are well known in the art no further explanation will be given. The axle member 15 may be easily and selectively removed from the axle receiving member 10, and consequently from frame 9, by removing pin 16, shown in FIG. 4, pulling the axle member 15 from the axle receiving member 10 and replacing therewith a new axle member 15 of the same type, when repairing, or of a different type or length axle member 15′, not shown, when changing the wheel base of the mower 5. In this manner, the power head frame 9 is modular and accommodates easy replacement or repair of the axle member 15. Therefore, the present invention reduces the amount of time it takes to replace the axle member 15, as well as, providing the power head frame with the modularity of utilizing different length axle members 15′, not shown, to accommodate different wheel bases.

With continued reference to FIG. 5, the top mounting plate 12 shows first and second sets or patterns of holes 45, 46 fashioned therein for use in securing an engine 8 to the top mounting plate 12. In the preferred embodiment, more than two sets of holes may be incorporated into the top mounting plate 12 for securing the engine 8 in a plurality of positions or for accommodating a different engine 8′, not shown, having a different size or configuration. Two sets of holes are shown here for ease of illustration only. Fastening bolts, not shown, are received by one set of holes, 45 or 46, and the engine 8, for use in rigidly securing the engine 8 to the frame 9. The sets of holes 45, 46 may be threaded to receive threaded bolts, which is well known in the art. In this way, fastening bolts, not shown, may be selectively applied to any set of holes 45, 46 fashioned within the top mounting plate 12 for use in securing the engine 8, or an alternate engine 8′, not shown, in a suitable position to facilitate making the power head frame 9 modular.

While specific embodiments of the invention have been described and illustrated, it is to be understood that these embodiments are provided by way of example only and that the invention is not to be construed as being limited thereto, but only by proper scope of the following claims.

It is now claimed:

1. A vegetation mower, comprising:
a frame;
a mower deck operatively attached to said frame, said mower deck having at least a first cutting blade;
an axle receiving member fixedly attached to said frame;
an axle received within said axle receiving member, said axle adapted to receive at least a first ground engaging wheel;
fastening means for fastening said axle to said axle receiving member; and,
an engine operatively attached to said frame for use in supplying power to said at least a first cutting blade.

2. The vegetation mower of claim 1, wherein said frame is adapted to receive said engine in a first mounting position, and wherein said frame is also adapted to receive said engine in a second mounting position.

3. The vegetation mower of claim 2, wherein said frame has a first set of bores defining said first mounting position and a second set of bores defining said second mounting position.

4. The vegetation mower of claim 2, wherein said frame is adapted to receive one of a plurality of substantially different engines.

5. The vegetation mower of claim 1, wherein:
said axle receiving member has at least a first bore;
said axle has a first hole, said axle adapted to be positioned such that said first hole is concentrically aligned with said at least a first bore; and,
said fastening means includes a pin that is selectively receivable within said at least a first bore and said first hole.

6. The vegetation mower of claim 5, wherein said frame includes first and second side plates extending from opposite ends of said frame member, said first and second side plates having first and second apertures, respectively;
wherein said axle receiving member is fixedly attached between said first and second side plates; and
wherein said axle is selectively received by said axle receiving member and said first and second apertures.

7. The vegetation mower of claim 6, further comprising:
at least first and second reinforcement plates having a first hole, said reinforcement plates being fixedly attached to said side plates, respectively; and,
wherein said axle is received within said first hole of said at least first and second reinforcement plates.

8. A method of assembling a vegetation mower, comprising the steps of:
providing a frame, a mower deck having at least a first cutting blade for use in cutting associated vegetation wherein said mower deck is operatively connected to said frame, an engine for providing power to said at least a first cutting blade, and an axle receiving member fixedly attached to said frame;
providing first and second axles wherein said first axle is substantially longer than said second axle member;
selecting either of said first and second axle members for use in selectively adjusting the wheel base of the mower;
inserting either of said first and second axle members into said axle receiving member; and,
fastening either of said first and second axle members to said axle receiving member.

9. The method of claim 8, wherein fastening said either of said first and second axle members includes,
providing said axle receiving member with a first bore, each of said first and second axles with a first hole and a pin;
concentrically aligning said first bore with said first hole; and,
inserting said pin into said first bore and said first hole.

10. A method for replacing an axle, comprising the steps of:
providing a frame member, an engine operatively attached to said frame for providing power to at least two ground engaging wheels, an axle receiving member fixedly attached to said frame, a first axle received within said axle receiving member for use in supporting said at least a first ground engaging wheel, and fastening means for fastening said axle to said axle receiving member;
unfastening said fastening means;
removing said first axle from said axle receiving member;
placing a second axle into said axle receiving member; and,
reattaching said fastening means.

11. The method of claim 10, wherein unfastening said fastening means includes,
providing said axle receiving member with a first bore, each of said first and second axles with a first hole, wherein said first bore is concentrically aligned with said first hole and a pin inserted into said first hole and said first bore; and
removing said pin from said first bore and said first hole.
